(19) United States
(12) Patent Application Publication
(10) Pub. No.: US 2006/0235897 A1
(43) Pub. Date: Oct. 19, 2006

(54) Mapping information technology system architecture

(76) Inventor: Charles G. O'Hara, Columbus, MS (US)

Correspondence Address: DLA PIPER RUDNICK GRAY CARY US LLP;ATTN: PATENT GROUP, 1200 NINETEENTH STREET, NW, WASHINGTON, DC, 20036, US

(21) Appl. No.: 11/279,820

(22) Filed: Apr. 14, 2006

Related U.S. Application Data
(60) Provisional application No. 60/671,518, filed on Apr. 15, 2005.

(51) Int. Cl. G06F 17/30

(52) U.S. Cl. 707/200

(57) ABSTRACT

A web-delivered mapping information technology (IT) architecture enables map user communities to effectively participate in distributed, collaborative creation of custom mapping content and the modernization and maintenance of critical map information. The IT architecture systematizes critical information technology and management functions to 1) organize user communities with similar mapping interests, 2) quantify user community characteristics, 3) identify individual user resources and needs within the user community, 4) identify gaps in needed resources, technology readiness levels, and capabilities, 5) deliver appropriate data products, tools, services, interfaces, and value added products to enable successful collaborative map modernization and maintenance activities, and 6) store, manage, share, and distribute (as designed per user community) the enhanced mapping products of each group.

### CROSS-REFERENCE TO RELATED APPLICATIONS

The present application claims priority to U.S. provisional application ser. no. 60/671,518 filed on Apr. 15, 2005, the entire contents of which are incorporated herein by reference.

### FIELD

The present application relates generally to map technology and more particularly to a system and method for processing map data.

### BACKGROUND

Current federal map enhancement programs focus on idealized super-portals such as the envisioned ‘GeoSpatial One Stop’ of the FGDC or the ‘National Map’ of the USGS. These super-portals are intended to deliver national views of spatial data and/or metadata harvested from the efforts of state and local government user communities. However, these programs are flawed in overall approach because they—
Completely lack user-level collaborative involvement;
Disregard the importance of identification of individual user or producer roles, responsibilities, capabilities, and interests;
Fail to quantify participating organization's and user's technology readiness levels;
Compile inputs from organizations on an ad hoc basis without an overarching mechanism for user input and feedback;
Fail to provide integrated approaches or efficient methods of data update, review, QA procedures; and
Do not provide the user communities with efficient methods of developing their own sets of customized maps products that leverage their enhanced data along with enhanced data from other user communities and generally available basemap layers.

The aforementioned deficiencies are readily apparent in the Master Address File/TIGER Accuracy Improvement Program (MTAIP), which is a high-priority national program by the U.S. Census Bureau Road Centerline modernization maintenance is This program involves a multi-year $200,000,000 (200 million dollar) contract to Harris Corporation to collect enhanced road centerline data for the entire country. The MTAIP contract runs through 2008 and is intended to provide significantly improved and highly accurate data for the 2010 U.S Census. The aim of the program is to improve the horizontal accuracy of the road centerline geometry to within a CE95 accuracy of 7.6 meters by realigning the TIGER as well as ensuring attribution of the data for street names and address ranges. The program aims to work with states, counties, tribes, and local government to acquire the updated data sets, and where these entities can not provide enhanced data, the program will seek to contract out the work. The program aims also to provide a minimum level of attribution for the enhanced data and also intends to develop image based methods of conducting change detection to add efficiency to maintenance and update procedures.

In the case of MTAIP, progress is good, but there are major bottlenecks in the process. Participation by state, local, county, and tribal groups is entirely ad hoc. There is no distribution mechanism for making available standard data sets to provide a uniform baseline for realignment of road centerlines, and there are no uniformly available image data sets that user communities may leverage for heads-up realignment activities. Furthermore, there are no tools for checking realignment, attribute consistency, data quality, or the completeness of processing. In sum, there is no integrated approach to managing or conducting a nationwide spatial information and enhancement program. The reason that there is no integrated approach provided is that there is no available architecture to deliver integrated data, resources, and tools to a designated user community for the purpose of generating standards-based enhancements to specific data sets of vital importance to a critical national user community.

### BRIEF SUMMARY

Some or all of the aforementioned shortcomings are addressed to a large extent by a distributed mapping information and technology architecture that facilitates the formation of user communities and provides user configurable web-delivered sets of integrated technologies to enable effective collaborative involvement in the creation of customized, modernized, and updated (maintained) spatial data sets with rich attribution capabilities. In one embodiment, the architecture is a distributed, multi-tier architecture that includes a collection of databases and database security and management services in a back end, middleware applications that provide web services, data transformation, web security, web-mapping and other functions, and a front end including session management, user management and a run time application.

### BRIEF DESCRIPTION OF THE DRAWINGS

FIG. 1 is an architectural design diagram for a system for a collaborative mapping information technology system according to an embodiment of the invention.

FIG. 2 is a relational diagram illustrating the relationships and interactions among individuals and user communities which illustrates user community processes as well as processes that link individuals to user communities.

### DETAILED DESCRIPTION

The present invention will be discussed with reference to preferred embodiments set forth below. Specific details, such as specific services and standards, are set forth in order to provide a thorough understanding of the present invention. The preferred embodiments discussed herein should not be understood to limit the invention. Furthermore, for ease of understanding, certain method steps are delineated as separate steps. However, these steps should not be construed as necessarily distinct nor order dependent in their performance.

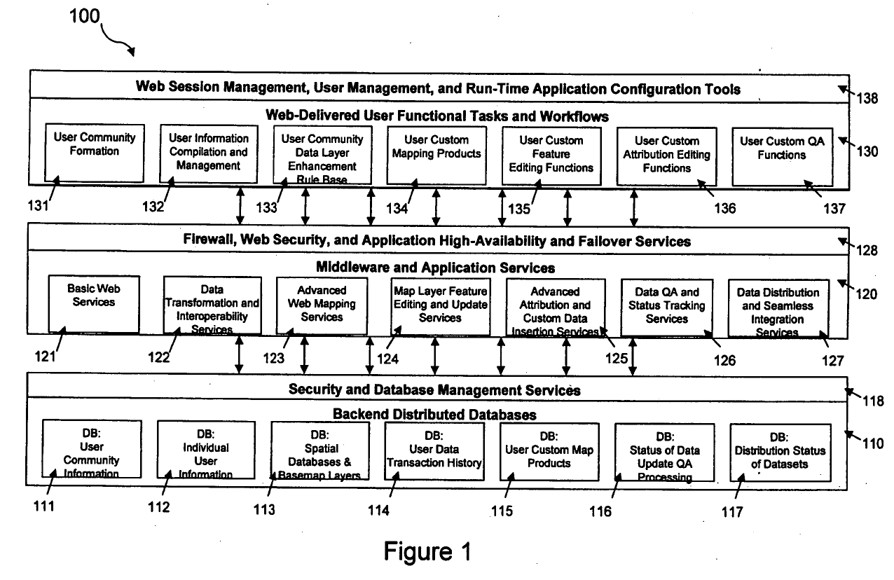

In one preferred embodiment shown in FIG. 1, a collaborative mapping information system 100 is built on a distributed, multi-tier architecture with a collection of databases in a backend, database security and database management services, middleware services for web services, data transformation, web-mapping and other functions, application services, and web-based delivery of content, applications, and data-driven processing tools to users for conducting effective mapping enhancement workflows. The system design is preferably built upon standards of the Open GIS Consortium (OGC) and, insofar as practical, leverages tools in the open source as well as COTS (commercial off-the-shelf) products and tools to ensure wide acceptance and robust usability. Components of the backend 110, middleware and application services 120, and frontend web-delivered tools and interfaces 130 are designed to provide users with control over data-, service-, and application-specific configuration settings to optimize the user experience and make data processing and creation as effective and efficient as possible.

Backend 110 components and databases enable granular control over the development of user communities, enable compilation of user information, provide access to a wide variety of standard datasets for basemap development and background viewing to facilitate quality updates and attribution, track user histories so that transactions may be efficiently reviewed and managed, track information about custom map products developed by users and user communities, store information about the status of feature and attribute updates, and provide information about the distribution and status of requests for datasets.

A set of databases 111 store information about a spatial database user communities, their critical spatial data layers, spatial accuracy and attribute requirements for each layer, as well as metadata requirements for each layer. The databases store information about custom maps and mapping products that have been customized by user communities for the purposes of highlighting specific data layers of importance to that group.

A set of databases 112 stores information about each registered user, user communities in which they participate, their roles and responsibilities in each relevant user community, and information about their technology readiness level, the types of data they have access to and can provide or share, the types of data that they desire, and the types of data that they must maintain.

A set of databases 113 stores copies of the spatial databases of user communities as well as provides access to a rich set of data for basemap development including historical and recent image data, raster graphics of USGS quadrangle maps, DEM elevation datasets, and a wide range of vector data sets to represent thematic layers of interest that will provide ancillary data that assist users in their update and maintenance tasks.

A set of databases 114 tracks user transactional activities to update spatial feature and attribute data. Transactional histories allow version control over updates, granular control over editing and QA procedures, as well as the ability to “roll back” specific sets of updates if they are determined to be undesired.

A set of databases 115 stores information about custom map products that have been created by individual users for their purposes as well as the degree to which the user wishes to share or distribute custom map products.

A set of databases 116 stores information about the update status of user submitted data enhancements or additions. Each user community has a defined set of requirements and procedures for QA processing and tracking. Furthermore, QA functions and actions will be tracked and persons or processes conducting QA will result in logs of activities that will provide users with direct feedback about the quality and status of their submitted work.

A set of databases 117 stores information about the distribution configuration for databases and tracks requests for specific datasets, downloads of specific datasets, use of each dataset in custom map products, and use of each dataset as a background layer used in editing and updates.

A complete security, high-availability database management solution 118 effectively ‘wraps’ the back end 110 to provide secure databases, high-availability for continuity of operations, and standard processes for backups and replication to offsite locations solution

A set of middleware and application services 120 enable the delivery via the web of a rich suite of applications for developing mapping products, updating map information, tracking the status of QA procedures, transforming data to ensure seamless access and maximum, and distributing customized maps as well as updated map products.

A set of basic web services 121 are provided by multiple web servers utilizing active load balancing and high-availability failover functionalities.

Data Transformation and Interoperability Services 122 transform data into user desired projection, datum, and other operational characteristics so that user-specific data may be leveraged in a manner that is fully interoperable with generally available basemap layers. In addition, data manipulation functionalities are available for uploading and using a variety of vector and raster GIS and image data formats.

Advanced Web Mapping Services 123 include OGC compliant web mapping services, catalog services, and advanced tools for creating and distributing Custom map products are provided via the implementation of technologies such as java-enhanced web-mapping interfaces, SVG for controlling layers utilized in the web mapping display, GML for providing enhanced markup language for layer presentation and symbol, and enhanced tools for designating areas of interest (AOIs), measuring features of interest, and selecting desired layers for download, manipulation, or symbol enhancement within specified AOIs.

Map layer feature editing and update services 124 are implemented using an extensible set of open standards-based tools deployed in a functionally complete feature editing and update environment. Vector selection and manipulation, splitting addition, deletion, movement, and snapping will be enabled. In addition, session history will provide the ability to review edit steps and roll-back to specific points in a history of transactions or to select a specific transaction for modification.

Advanced attribution and custom data insertion services 125 provide users with the ability to attribute new features as well as check the completeness of required attributes for existing features.

Data QA and status tracking services 126 provide a QA environment that enables review of feature and attribute edits. Tools for analysis of lines that undershoot, overshoot, contain pseudo-nodes and other potentially undesired features are provided. Analysis functions that enable quantification of feature accuracy and representational integrity are also provided. In addition, users have access to a set of run-time tools that can be used off-line to conduct additional QA on feature data sets. Attribute QA tools enable the review of attribute completeness and integrity across the entire dataset as well as for those features that were edited. A set of QA reports are available for describing the quality of feature and attribute edits as well as quality characteristics of the dataset in question.

Data distribution and seamless integration services 129 maintain version control of data, track user access to data sets, notify users of data update status, updates from catalog services that provide information about data that are being enhanced, processing status so that availability timeframes for enhanced data may be better estimated. Also included are data integration services that provide distribution of virtually seamless data.

A set of services 128 wrap the middleware and application services mentioned above. Firewall and web security functionality provide a robust middleware and application services environment that will allow necessary application services and user functions, but block undesired traffic and activity or functional interaction between users, services, and applications. Redundant servers provide a high-availability environment, load-balancing provides a high-performance environment, and transactional histories allow users to work without fear of lost time and lost edits.

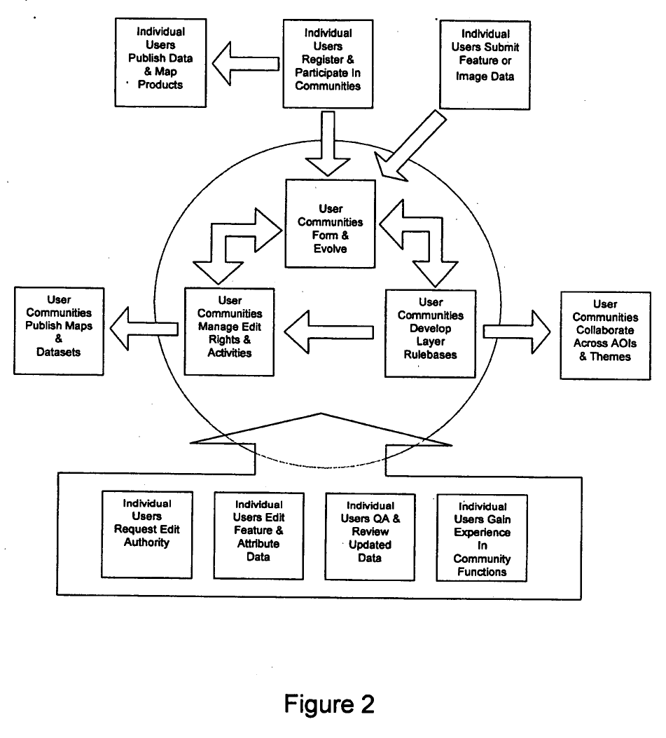

A series of web delivered interfaces 130 are provided to enable the efficient performance of tasks and workflows as well as the generation and sharing of custom map products and data sets within and across user communities. The relationships and interactions among individuals and user communities is shown in FIG. 2, which illustrates user community processes as well as processes that link individuals to user communities.

A set of interfaces 131 are provided for the creation of user communities. User communities may have a similar set of operation requirements and/or data layers of critical interest that they wish to modernize, use, improve, enhance, maintain, and distribute. User communities may develop standard map products with default layers included and symbologies defined for feature representation. User communities have the ability to regulate the distribution of their standard map products as well as their data layers. Additionally, user communities have the ability to restrict participation on the community via moderated procedures that typically involve application and nomination of prospective members, secondary supportive input from colleague members in good standing within the user community, and review and approval from user community leaders. User communities may develop internal hierarchies of user levels with gradational participation granted in which case new users have limited abilities to manipulate, edit, or modify data within the user community. More advanced members of the user communities have increased access and abilities to edit, manipulate, and modify datasets.

User information compilation and configuration settings management services 132 compile and store information and manage configuration settings for users. Individual users will participate in user communities that relate to their jobs, communities that maintain data in which they have personal interests, or communities that maintain data for which they have operational needs. Users will effectively join communities via specific interfaces wherein they indicate their geographic AOIs, their roles and responsibilities for data use, update and maintenance, and their technology readiness level to contribute data, support services, QA assistance, and/or other functional or technical or data support to the community. In some cases, users may participate by contributing enhanced image data or other ancillary data sets that shall provide improved ability to update feature data sets of interest. For datasets contributed, users will be able to set restrictions on the use and distribution of the data provided. Processes for joining user communities shall develop over time, but may involve vetting processes that shall be emplaced to ensure that data are protected by minimum standards that ensure that users fully understand the data requirements for standard data and how to utilize available tools and methodologies to ensure quality data products.

A user community data layer enhancement rulebase 133 allows user communities to set priorities upon data layers of interest, set required minimum attribution standards, specific accuracy requirements for feature datasets, and specify routines that should be followed to ensure that data meet the QA standards set for the data layers of interest. User community rulebases may be developed by the community and tools are provided to enable the development of fully controlled data workflow processes or completely unrestricted access to specific datasets for updates. Typically, a user will request the ability to update data for their geographic AOI. The request will typically be made via a user configuration setting request for modification of a specific user community dataset for a given geographic AOI. A specific individual within the user community will typically be given control over granting edit and update rights for specific datasets within geographic AOIs. Although user community rulebases may be modified and refined to suite the needs of the user community, default guidelines will nominally place dataset control with specific individuals who have operational maintenance responsibilities for the dataset as part of their job for a geographic area. If user communities develop participation hierarchies, some individuals may work on dataset enhancement, other individuals may serve as QA reviewers, some may act as editors of updates and pass on recommendations to accept updates or reject specific feature or attribute changes. In some cases, user communities will lack participation and resources for such layered involvement and users will manage their own edits, QA, review checks, and acceptance.

Individual users will have the ability to create and distribute custom map products using custom mapping products 134 These mapping products may draw upon a general suite of basemap layers and would typically include layers from user communities in which the individual user participates. Therefore, if the user works to update road centerlines for a state or county, it would be reasonable to expect that they would create custom maps that would include their updated spatial dataset in a modernized map product that they could publish and distribute along with the distribution of their dataset. In other cases, users might create maps of items in which they have personal interest that might include outdoor recreation activities such as biking trails, hiking maps, bird watching maps, or a wide variety of other special interest custom map products around which entirely new user communities might organize to provide modernized and updated spatial data sets. Maps will be developed and delivered as online or offline documents in which the layer properties and symbologies shall have rich configurable setting to optimize the display and presentation of map data of interest as well as the distribution and portability characteristics of the map product.

After requesting and being granted authority to edit specific spatial dataset features within an AOI, users have access to a feature editing application interface and environment 135 with an extensible set of open standards-based tools for functionally complete feature editing and update, Vector selection and manipulation, splitting, addition, deletion, movement, and snapping are enabled, The environment also tracks session history and provides the ability to review edit steps and roll-back to specific points in a history of transactions or to select a specific transaction for modification.

Users also have access, after requesting and being granted authority to edit specific spatial dataset attributes within an AOI, to a set of user custom feature editing functions 136 that provide the ability to attribute new features, update attributes of existing features, and check the completeness of required attributes for existing features,

Users further have access to a QA environment that will enable review of feature as well as attribute edits using the user custom QA functions 137 after requesting and being granted authority to conduct QA on specific spatial dataset features and/or attributes within an AOI. In the QA environment, tools for analysis of lines are provided, including tools to check for lines for undershoot, overshoot, pseudo-nodes and other potentially undesired features. Analysis functions will be deployed to enable quantification of feature accuracy and representational integrity. For advanced QA, a set of run-time tools that can be used off-line to conduct additional QA on feature data sets may be downloaded and used on a local version of data. Reviewers will be required to screen data through the use of attribute QA tools to ensure attribute completeness and integrity across the entire dataset as well as for those features that were edited. After users have completed their processing, QA reports are automatically generated to list the features and attributes updated, the editorial problems encountered, and the status or required fixes for problems. QA reports contain a quantification of the quality of feature and attribute edits conducted by individual users as well as the overall quality characteristics of the entire dataset in question for a specified AOI.

A complete set of management and configuration tools 138 will be deployed along with the web interface that allow users to configure their web environment, customize map display settings, change user community settings, and specify default values for session participation. Sessions activities are preferably fully logged and user community activities are tracked so that activities may be managed. In addition, edit and update transactions are maintained both in database tables as well as in a session history file. In cases where a session is lost, the user may reconnect and the state of the session may be restored such that activities may be picked up where the user left off. To some extent, the user may be presented with options to resume last session at the status prior to log-off/disconnect, or given the option to connect using user defined default settings as the starting point for the session.

While various embodiments of the present invention have been described above, it should he understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

Moreover, the methods and systems of the present invention, like related systems and methods used in the imaging arts are complex in nature, are often best practiced by empirically determining the appropriate values of the operating parameters, or by conducting computer simulations to arrive at best design for a given application. Accordingly, all suitable modifications, combinations and equivalents should be considered as falling within the spirit and scope of the invention.

In addition, it should be understood that the figures, are presented for example purposes only. The architecture of the present invention is sufficiently flexible and configurable, such that it may be utilized in ways other than that shown in the accompanying figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed is:

1. A multi-tier system for the distributed, collaborative creation and maintenance of mapping information by a community of users, the system comprising:
a backend comprising a plurality of distributed data storage devices, the data storage devices having a plurality of databases stored thereon, the databases comprising an individual user information database, a user community database, and a map information database;
a front end comprising at least one first server configured to provide services for forming user communities, compiling and managing information for users in the communities; and
a middle tier comprising at least one second server configured to access the plurality of data storage devices and provide applications for developing mapping products and editing map information stored in the plurality of data storage devices, the map information including map features and map attributions.

2. The system of claim 1, wherein the back end further comprises a database for tracking a distribution status for map information stored in the plurality of data storage devices.

3. The system of claim 1, wherein the back end further comprises a user data transaction history, the user data transaction history tracking user transactions involving updates to map feature and attribute data.

4. The system of claim 1, wherein the back end further comprises a custom map product database that includes information pertaining to custom map products created by users.

5. The system of claim 1, wherein the back end further comprises a quality assurance database that includes procedures and requirements applicable to a particular community for quality assurance processing and tracking.

6. The system of claim 1, wherein the at least one first server is further configured to provide services for implementing user custom feature editing functions.

7. The system of claim 1, wherein the at least one first server is further configured to provide services for implementing user custom attribution editing functions.

8. The system of claim 11, wherein the at least one first server implements a user community defined rulebase for governing editing and updating rights to the map information.

9. The system of claim 1, wherein the at least one second server is further configured to provide data transformation services to transform data into a desired format.

10. The system of claim 1, wherein the at least one second server is further configured to maintain version control of the map information stored in the map information database.

11. A method for collaborative distributed map information processing comprising the steps of:
creating at least one community of users who wish to collaborate in the update of map information, the map information being stored in a distributed map information database;
storing user information for each of the users in the at least one community in a user database, the user information including areas of interest for each user, types of data that the user has permission to view, and types of data that the user has permission to modify;
providing tools for updating the map information by users in the community in accordance with the user database;
providing tools for checking a quality of updates to the map information by users in the community: and
distribute the updated maps to users in the community.

12. The method of claim 11, further comprising the step of tracking updates made to the distributed map database and providing a supervisory member of the community with the ability to reverse map updates.

13. The method of claim 11, further comprising the step of providing tools to allow users to create custom map products based on base map information stored in the distributed map database.

14. The method of claim 11, wherein updates to the map information by users include updates to map features.

15. The method of claim 11, wherein updates to the map information by users include updates to map attributions.

16. The method of claim 11, further comprising the step of transforming data in a first format to a format of map information stored in the map database.

17. The method of claim 11, further comprising the step of compiling a history of updates to the map information made by a user.
